(19) United States
(12) Patent Application Publication
(10) Pub. No.: US 2009/0041959 A1
(43) Pub. Date: Feb. 12, 2009

(54) Insulating Label Having Paper Core And Cellulose Acetate Outer Layers

(75) Inventors: Laura Dellevigne, Danbury, CT (US); Jeffrey T. Sloat, Broomfield, CO (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo., Inc., Purchase, NY (US)

(21) Appl. No.: 11/835,048

(22) Filed: Aug. 7, 2007

(51) Int. Cl. B32B 27/10; B32B 1/08

(52) U.S. Cl. 428/34.2; 428/35.7; 428/36.5

(57) ABSTRACT

An insulating label has a low-density core layer disposed between a plurality of polymeric layers of cellulose acetate. The polymeric layers can be laminated to the core layer using techniques such as extrusion, adhesive lamination, or a combination thereof. Indicia can be applied to one or more of the polymeric layers and/or the core layer.

### DESCRIPTION OF RELATED ART

Insulating labels have been developed for insulating containers for hot beverages while protecting the consumer from burns. One current label utilizes a polymeric film that is extrusion laminated to a non-woven polyolefin insulation layer. The label can be supplied in roll form and applied to containers, such as 9 oz. steel cans, using a Krones Contiroll labeler or similar labeling equipment. A low viscosity (e.g., 400-1200 cPs) hot-melt thermoplastic adhesive is used to affix the label to the container. One disadvantage is that the hot-melt adhesive is prone to re-softening when the beverage is heated in the vending unit. The softening of the adhesive can result in the label becoming separated from the container, thereby compromising package integrity as well as its insulating and safety properties.

Another type of insulating label is prepared by oriented polystyrene foam/polystyrene film lamination. A reverse-printed polystyrene film is adhesive laminated to a foamed polystyrene insulation layer. The structure is typically supplied in roll format and applied to containers using a Krones Contiroll labeler or similar labeling equipment. Instead of using a hot-melt adhesive, the polystyrene label is solvent-welded together. A solvent is applied to the lap portion of the label during labeling and the solvent dissolves the polystyrene polymer. The label is then seamed together where the dissolved polystyrene resin welds the two sides of the label together, thereby creating a seam without the use of glue. However, the overall heat resistance of the polystyrene label is poor, resulting in label melting and “burn-through” during heating.

U.S. Pat. No. 6,620,281 to Sommers describes an insulating label that utilizes a top printed film that is laminated to a foam web for the insulation material. The label is manufactured so that a section of the foam is voided from the label surface, acting as a glue-applied flange for affixing of the label onto a container. The foam is relatively thick (>0.010″) relative to typical label thicknesses, resulting in significant inefficiencies during converting. Likewise, the process of constructing a voided flange is very complicated and not within the normal realm of high speed converting operations.

U.S. Pat. No. 7,070,841 to Benim et al. describes an insulating label stock that is comprised of a thermal insulation layer that is laminated to a face stock that itself has two layers, one of these sub-layers being a heat-sealable layer. The entire label construction is claimed to possess a minimum thickness of 0.0075″. The thermal insulation layer is described as a fiber-filled batt, and the four edges of the label are sealed so that moisture cannot wick into the insulation layer and destroy the insulation properties of the structure. The thickness of the Benim label, which is excessive for a label substrate, results in a label that possesses a higher stiffness and is therefore difficult to apply to a container using typical high speed label applications. U.S. Pat. No. 7,108,906 to Benim describes a similar insulating label material but which is heat shrinkable. The label also has a minimum thickness of 0.0075″.

### SUMMARY OF THE INVENTION

In one aspect, an insulating label includes a laminated structure having a low-density core layer disposed between a plurality of polymeric layers of cellulose acetate. The cellulose acetate layers can be laminated to the core using numerous conventional techniques such as extrusion, adhesive lamination (water-based, solvent-based, energy curable, solventless), or a combination thereof. At least one layer of the label contains indicia. For example, indicia can be under-printed onto one or more of the polymeric layers and/or the core layer.

It was found the cellulose acetate layers provide exceptional heat resistance for the label, while enabling the label to be solvent-welded, thereby eliminating the need for a hot-melt adhesive. The label can have a thickness of less than about 0.007″ and has adequate strength and stiffness properties to allow for processing in high-speed labeling equipment. The label also does not require sealed edges to protect the internal core of the structure, thereby potentially simplifying the manufacturing process.

The label can use relatively inexpensive, non-foam materials for insulation, thus avoiding the need for polyolefin non-woven materials or other expensive insulating materials. Despite using inexpensive materials, it was found the label can still provide adequate insulating properties for hot beverage containers.

### BRIEF DESCRIPTION OF THE DRAWINGS

The objects, features, and advantages of the invention will be apparent from the following more detailed description of certain embodiments of the invention and as illustrated in the accompanying drawings in which:

FIG. 1 is a schematic cross-sectional illustration of an insulating label according to one embodiment of the present invention.

### DETAILED DESCRIPTION OF THE INVENTION

Unless otherwise clear from the context, any of the layers described herein either can be adhered directly to adjacent layers or can have additional layers present therebetween. As used herein, the term “lamination” refers to joining layers either with or without an adhesive layer (or “tie” layer).

The labels can be supplied in the form of label stock, which includes without limitation a plurality of labels, rolls of labels, precut magazine stacks of labels, or label feed stock. Label stock may be cut into individual lengths to make labels.

The labels can be attached to a container such as, but not limited to, a bottle, can, jar, pouch, or vial. The container can be a glass container, metal container, plastic container, or any other suitable packaging container. Such containers may or may not contain foodstuffs such as foods or liquids. The labels are particularly suitable for application to containers, such as steel cans, for use in applications in which a beverage is heated while in a vending machine prior to dispensation, although it should be understood the insulating label is not limited to such applications.

The label contains a low density core layer. The core layer typically includes a cellulose material, such as pulp and/or paper. Alternatively, other types of insulative materials, such as foam or non-woven materials, can be used as the core layer. The density of the core layer usually ranges from about 0.25 g/cm³ to about 0.75 g/cm³. The thickness of the core layer usually ranges from about 2 mils to about 5 mils. Core layers with thickness below this range can result in inadequate insulating properties, while thicknesses above this range can lead to difficulties in processing and handling of the label.

The label also has a plurality of polymeric layers comprising cellulose acetate. The term “cellulose acetate” is used herein to refer to different forms of cellulose acetate without limitation, such as cellulose diacetate and cellulose triacetate. The thickness of the polymeric layers usually ranges from about 14 μm to about 50 μm. In general, the thickness should be at least a minimum amount that provides structural integrity and enables solvent welding. Excessive thicknesses can lead to difficulties in handling the labels, particularly in high speed labeling equipment.

The label also may include one or more additional layers, such as adhesive layers or functional layers such as gas barrier materials, moisture barrier materials, glossy materials, materials that further enhance printability of one or more layers, scuff/wear resistant materials, and the like.

The label contains at least one layer comprising a material that is suitable for receiving indicia. The term “indicia” as used herein is a broad term and includes text, graphics, designs, pictures, trademarks, and the like. Indicia may be printed on any layer of the label and may be printed in a normal or inverse direction (sometimes referred to as reverse-printing or under-printing).

The cellulose acetate layer(s) can receive indicia on one or both of their surfaces. Alternatively, another layer or layers configured to receive indicia may be present. Examples of such indicia-receiving layers include polyolefins, such as polypropylene and/or polyethylene. Such materials are capable of receiving high definition color and images. Indicia also can be applied to the core layer and/or another cellulose/paper layer that may be present in the label.

The label may be affixed to an article through any suitable means. While solvent welding is advantageous because it avoids the need for a hot-melt adhesive, the label can be adhered to an article using any known technique, including by means of an adhesive.

Adhesive layers may be used to adhere the cellulose acetate layers to the core layer and/or other intermediate layer(s). A variety of materials can be used for adhesive layers, such as polyolefins, e.g., ethylene or propylene homopolymers or copolymers. Polypropylene or other polymers can be grafted or modified with polar groups including, but not limited to, maleic anhydride, glycidyl methacrylate, acryl methacrylate and/or similar compounds to improve adhesion. Maleic anhydride modified polypropylene homopolymer or maleic anhydride modified polypropylene copolymer can also be used. These materials may be interblended with other functional materials to aid in the adhesion of layers to each other or the article substrate material. A non-limiting example of an adhesive that can be used for laminating the cellulose acetate layers to a paper core layer is Bostik JB763.

Labels can be prepared having a thickness of less than 0.007″, providing suitable stiffness to allow for processing in high-speed labeling equipment, although the invention is not limited to any particular label thickness. The label does not require sealed edges to protect the internal core of the structure, thereby simplifying the manufacturing process, although the edges can be sealed if desired for aesthetic or other purposes.

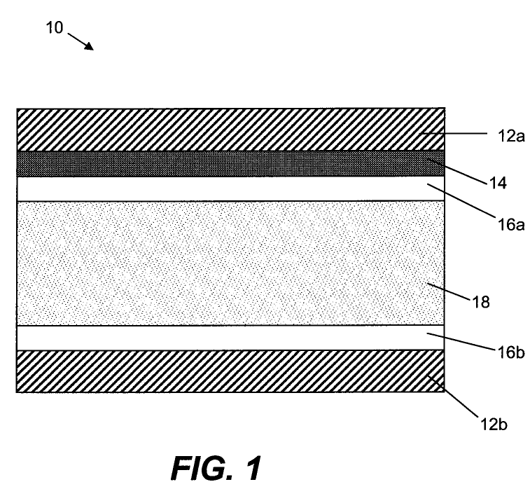

As illustrated in FIG. 1, an insulating label 10 can have a 3-ply laminated structure with a low-density paper core 18 sandwiched between outer polymer layers 12a and 12b of cellulose acetate. The cellulose acetate layers 12a and 12b can be laminated to the paper core using any of numerous conventional techniques such as extrusion, adhesive lamination (water-based, solvent-based, energy curable, solventless) or a combination of both. As shown in FIG. 1, adhesive layers 16a and 16b can be applied to the inside surfaces of the cellulose acetate layers 12a and 12b. Alternatively, the adhesive layers 16a and 16b could be applied to upper and lower surfaces of the paper core layer 18, respectively. An indicia layer 14 can be under-printed on the inside surface of the upper cellulose acetate layer 12a.

While FIG. 1 illustrates the cellulose acetate layers 12a and 12b as the outermost layers of the label, which is desirable to permit solvent welding as described herein, it should be recognized that the invention is not so limited. One or more additional layers may be applied to the outer surface(s) of the cellulose acetate layer(s) 12a and/or 12b for aesthetic and/or functional purposes.

Compared to label structures that use a polyolefin non-woven material as the insulation layer, the label of the present invention can utilize a relatively inexpensive core layer such as low-density paper, which potentially can yield a cost savings while still providing adequate insulating properties for the label.

When the upper and lower surfaces of the label are constructed from materials such as cellulose acetate, as illustrated in FIG. 1, the label can be conveniently sealed around a container using a solvent welding process. Cellulose acetate is organic solvent-soluble, for example with ketones such as acetone. By applying a bead of acetone to the seam of the label, the cellulose acetate layers soften and dissolve. As the solvent evaporates, the dissolved cellulose acetate re-solidifies as a single cellulose acetate structure, thereby welding the two halves of the label seam together.

### EXAMPLES

The following examples are provided for illustrative purposes only and should not be regarded as limiting the scope of the invention.

### Example 1

This example involved testing the suitability of cellulose diacetate films for solvent welding.

A 14 μm thick glossy cellulose diacetate film (Clarifoil®) was cut into ˜1 cm² pieces and placed into a 50 ml beaker. About 20 ml of acetone was then added to the beaker. All of the film pieces dissolved within about 5 seconds, indicating the film is very soluble in acetone.

A piece of the same type of film was cut into 4″×4″ pieces. Several drops of acetone were applied to one side of the cut piece in a stripe near an edge of the piece. The opposite edge was folded onto the area where the acetone was applied. The piece was effectively welded onto itself.

### Example 2

This example involved testing labels for heat resistance and processing characteristics. Desirable characteristics include solvent weldability at processing speeds of ˜600 cpm, the ability to wrap and transport on a vacuum cutter/gripper drum, the ability to withstand temperatures up to about 270° F., printability, and the ability to adequately insulate a consumer's hand during consumption (<120° F.).

A label was prepared having the following structure: 20 μm thick matte cellulose acetate film (Clarifoil®) base layer, 4 μm thick paper core layer, and 50 μm thick glossy cellulose acetate film (Clarifoil®) outer layer. The cellulose acetate films were laminated to the paper core using 3M™ Super 77™ Multipurpose Adhesive. The structure was relatively stiff, and when wrapped around a container the label “puckered” slightly due to the different circumference of the inside and outside layers. It was found that by allowing the label to cure overnight before wrapping it around the container, the problem of puckering was avoided. The labels had an overall thickness of ˜165 μm.

Insulating properties were tested by applying the labels to steel cans. The cans were filled with water, which was heated to ˜140° F. The temperature of the liquid and the temperature of the outside surface of the label were measured to assess the label's insulating properties. The results were compared to a control, namely a polymeric film extrusion laminated to a non-woven polyolefin insulation layer. The control label had an overall thickness of ˜224 μm. Table I summarizes the temperatures of the liquid and the outside label surface. The liquid was added to the containers and allowed to sit for 5 minutes prior to taking the temperature measurements.

TABLE I

| Trial | Control | T (° F.) | ΔT | Example 2 | T (° F.) | ΔT |
|---|---|---|---|---|---|---|
| 1 | Liquid | 133 | 12 | Liquid | 132 | 13 |
| | Surface | 121 | | Surface | 119 | |
| 2 | Liquid | 132 | 14 | Liquid | 130 | 14 |
| | Surface | 118 | | Surface | 116 | |
| 3 | Liquid | 131 | 14 | Liquid | 129 | 12 |
| | Surface | 117 | | Surface | 117 | |

As evident from Table I, the label of Example 2 exhibited insulating properties that were about the same as the control, even though the control label (˜224 μm) was approximately 35% thicker than the label of Example 2 (˜165 μm).

The labels also were tested for heat resistance. An oven was heated to 230° F. Empty cans containing the label of Example 2 and empty cans containing the control label were placed in the oven for 15 minutes. Both labels exhibited slight shrinkage, which caused the underlying reinforcing bands to become visible through the label. Otherwise there were no adverse effects on the labels.

While particular embodiments of the present invention have been described and illustrated, it should be understood that the invention is not limited thereto since modifications may be made by persons skilled in the art. The present application contemplates any and all modifications that fall within the spirit and scope of the underlying invention disclosed and claimed herein.

What is claimed is:

1. An insulating label comprising a laminated structure having a low-density core layer and a plurality of polymeric layers comprising cellulose acetate, wherein at least one of the layers has indicia thereon.

2. The insulating label of claim 1, wherein the core layer is selected from the group consisting of cellulose materials, foam, and non-woven materials.

3. The insulating label of claim 2, wherein the core layer comprises paper.

4. The insulating label of claim 1, wherein each of the polymeric layers is laminated to the core layer by an adhesive layer.

5. The insulating label of claim 1 wherein at least one surface of a polymeric layer has indicia printed thereon.

6. The insulating label of claim 1, wherein the core layer has a density ranging from about 0.25 g/cm³ to about 0.75 g/cm³.

7. The insulating label of claim 6, wherein the core layer has a thickness ranging from about 2 mils to about 5 mils.

8. The insulating label of claim 1, wherein each of the polymeric layers has a thickness ranging from about 14 μm to about 50 μm.

9. The label of claim 1, wherein the label has an overall thickness of less than about 0.007″.

10. The label of claim 1, wherein each of the polymeric layers comprises cellulose diacetate.

11. A container having an insulating label of claim 1 affixed thereto by solvent welding.

12. An insulating label comprising a laminated structure having a low-density core layer and a plurality of polymeric layers, the label comprising:
a first polymeric layer comprising cellulose acetate;
indicia reverse-printed onto the first polymeric layer;
a first adhesive layer;
a core layer comprising paper;
a second adhesive layer; and
a second polymeric layer comprising cellulose acetate.

13. The insulating label of claim 12, wherein the core layer has a density ranging from about 0.25 g/cm³ to about 0.75 g/cm³.

14. The insulating label of claim 13, wherein the core layer has a thickness ranging from about 2 mils to about 5 mils.

15. The insulating label of claim 12, wherein each of the polymeric layers has a thickness ranging from about 14 μm to about 50 μm.

16. The label of claim 12, wherein the label has an overall thickness of less than about 0.007″.

17. The label of claim 12, wherein each of the polymeric layers comprises cellulose diacetate.

18. A container having an insulating label of claim 12 affixed thereto by solvent welding.
